(19) United States
(12) Patent Application Publication
(10) Pub. No.: US 2008/0008800 A1
(43) Pub. Date: Jan. 10, 2008

(54) Rice conditioning process and freezing of products made with such rice

(76) Inventor: Yamil Adiv Maccise Sade, Cancun Quintana Roo (MX)

Correspondence Address: Welsh & Katz, Ltd.;Daniel M. Gurfinkel, 22nd Floor, 120 South Riverside Plaza, Chicago, IL, 60606, US

(21) Appl. No.: 11/510,425

(22) Filed: Aug. 24, 2006

(30) Foreign Application Priority Data
Apr. 25, 2006 (MX) PCT/MX2006/000024

(51) Int. Cl. A23L 1/18; A23L 1/20

(52) U.S. Cl. 426/450; 426/626

(57) ABSTRACT

The foregoing invention generally is related to the food industry and more particularly to the manufacturing industry of frozen rice containing foodstuff. It has the advantage of increasing shelf life to 9 to 12 months for products made with rice; that can be frozen, and when thawed this product retains proper consumption qualities; with products of various qualities for the different tastes of consumers, and allows satisfaction of the great demand of this product at any time, day, afternoon, evening, and anywhere in the world. This process comprises a rice conditioning process and freezing of products made with said rice, of the type that includes rice washing, cooking, and curing with a vinegar, sugar, and salt solution, and is then used to prepare a meal that contains said rice characterized by said cooking process being conducted in a hydrocolloid solution, and following said curing process a hydrocolloid solution is sprayed onto said cured rice, and, once the meal is prepared, it is frozen by immersion in liquid nitrogen, and after said product is frozen a hydrocolloid is glazed upon it.

### FIELD OF THE INVENTION

This application is a continuation of International Application No. PCT/MX2006/000024 filed on Apr. 25, 2006. The foregoing invention generally refers to the food industry and more particularly to the manufacture of frozen precooked rice products.

### BACKGROUND OF THE INVENTION

Currently, products made with rice in general, and sushi in particular, are products that are not frozen, but are kept just above freezing temperatures, i.e., refrigeration temperatures.

A typical process of the prior art for treating rice before making a finished product consisted on washing the rice, allowing it to sit for 35 minutes, cooking it for 20 to 25 minutes; then cure it with a mixture of vinegar, salt, and cane sugar, and finally make the product. This status of the art means their conservation is short term, having a restricted shelf life, because changes begin relatively soon evidencing the effects of the product's enzymes, oxygen in the environment, and microorganisms in the product. Being able to freeze these products would result in their increased shelf life.

Products comprising rice in their formulation, sushi rolls and nigiri sushi among them, present a serious drawback when frozen for their conservation, distribution, and sale.

When thawing a roll for consumption, rice completely changes its organoleptic characteristics, loosing its fluffiness, softness, and good appearance; in brief, it dehydrates and acquires a waxy texture and therefore becomes hardly edible.

An explication was found while analyzing this phenomenon, stating that water contained in the rice, while freezing the product, froze forming big crystals and breaking the fluffy structure of cooked grains, which do not loose their original shape while frozen because frozen water holds them together.

However, when the product is thawed, water crystals are dissolved and cease to hold the shape of the soft fluffy rice and water comes outside the grain, leaving it completely dry and waxy, which makes its tasty ingestion impossible. Technically, one may deem that if the product was frozen in a way that only forms small crystals that will not break the fluffy structure of the cooked rice, the latter could keep its appearance and texture.

Keeping the water from exiting the grain would also minimize the drying effect.

A process that overcomes this drawbacks in either of these two ways, even if the precise intrinsic effect was unknown, i.e., that whether the water produces microcrystals when frozen or water was kept from exiting the cooked grain, would result in a significant advancement over the prior art for this type of process.

### OBJECTIVES OF THE INVENTION

An objective is to increase shelf life for products made with rice, for their storage, distribution, sale, and consumption for 9 to 12 months, without diminishing their qualities.

Another objective of this foregoing invention, in order to achieve the objective above, is to achieve a generally rice product, and sushi in particular, that can be frozen and, once thawed, it will maintain appropriate consumption qualities.

Yet another objective is to achieve products with various qualities for different preferences of the consumers.

Another objective is to satisfy the large demand for this meal at any time, day, afternoon, evening, and anywhere in the world.

Other objectives and advantages of this foregoing invention may become apparent from the study of the following description and the examples, included for illustrative and not limitative purposes.

### BRIEF DESCRIPTION OF THE INVENTION

In general, the process of this invention involves, on one side, applying a special preparation to the rice that will be used for making products to be frozen, and more particularly to the preparation of sushi, and on the other side a freezing process for the product made with this rice.

This special preparation consists on adding certain food additives to the rice and under certain conditions in some stages of the treatment.

Four additives were determined to be added to the rice, one of them is a specific hydrocolloid; vinegar is another one, then cane sugar, and salt.

There are two types of hydrocolloids, one is a system of co-processed Xantano rubber encapsulated in acacia rubber (Arabic rubber), and the product marketed under the brand Thixo is one example. The other is a product obtained from the extraction in water or alkaline media of red sea weeds (carrageenan), just as the product marketed under the brand Irgel.

This invention has various embodiments, combining the type of rice, employed hydrocolloid or hydrocolloids, the moment on which hydrocolloids are added, percentage of added hydrocolloids, and finally, desired texture of the finished product.

Regarding the moment on which the hydrocolloids are added, and which hydrocolloids are added, it was determined that three of them are necessary, a combination of two colloids is added first, and then just one of them.

As to when to add hydrocolloids, the first one is added while cooking the rice, another one following its curing process with the vinegar, cane sugar, and salt solution, and the last one, optionally, after freezing the product made with this rice.

The glazing operation after freezing is done with a water solution of colloids at a temperature around 1° C.

Regarding amounts of hydrocolloids, they will depend on the step in the process where said colloid is added. In order to ease comprehension hereof, we shall designate this hydrocolloid added while cooking the rice hydrocolloid A, the one added during curing we will designate hydrocolloid B, and the one added after freezing the product we will designate hydrocolloid C.

Other aspects of the invention are related to the manner on which the product made with the rice treated in accordance to this invention is frozen, so that said freezing process modifies as little as possible the cellular structure of the rice and, therefore, when it is thawed, its structure will be kept intact, and it will maintain its organoleptic characteristics of consistency.

### DETAILED DESCRIPTION OF THE INVENTION

This rice conditioning process, and freezing of the products made with such rice includes the following steps:

### 1. Washing of the rice.

### 2. Cooking the rice in boiling water with hydrocolloid A.

### 3. Curing the rice with vinegar, cane sugar, and salt.

### 4. Spraying of hydrocolloid B on the rice product of the step above.

### 5. Making a meal with this conditioned rice.

### 6. Freezing of the foodstuff by immersion in liquid nitrogen.

### 7. Glazing this frozen product with the hydrocolloid C.

The rice wash is conducted until elimination of aleurone traces and other tissues of the grain is achieved, as a result of its polishing.

Cooking of rice is done in boiling water, containing the hydrocolloid A composition.

Curing of the cooked rice consists of adding a cane sugar and salt solution in vinegar to the rice. This addition is conducted until the desired amount of this solution is absorbed by the rice.

The next step following said rice curing is the formation of a superficial layer of hydrocolloid B on the rice; this hydrocolloid B is sprayed as a water solution of the hydrocolloid.

The foodstuff preparation step will depend on what type of meal it is, but this is already known in the art, and many times it only includes shaping or mixing ingredients, including rice prepared as mentioned above.

Freezing of the product is achieved by its immersion in liquid nitrogen for a time defined by the dimensions and characteristics of thermal exchange of this meal's components.

Glazing of this frozen product is done by sprinkling a water solution of hydrocolloids at a temperature around 1° C. A higher temperature of the solution could result in a temperature increase of the product until the solution absorbs energy enough to freeze.

Now, regarding composition of these hydrocolloids solutions and the curing solution it must be said that the quantity added must take many factors into consideration. One of them is the formation of an impermeable layer to avoid water drainage and thus maintain the texture given to the cooked, frozen, and then thawed rice. The thicker this sealing layer the better this layer works, however, a very thick layer will modify this rice's taste and its texture may be modified and become too firm.

The same applies to the amount of vinegar, sugar, and salt. Vinegar not only modifies the taste but if too much vinegar is added the pH level would become too low and rice starch could be chemically gelatinized, and render the product too soft.

Hence, determination of these parameters in the process is subject matter of this invention, both quantity of solution being added and the concentration of its components.

First, solution of hydrocolloid A, hydrocolloid added to the rice cooking water has a quantity from 5 to 8 grams of carrageenan for each liter of water.

Solutions of hydrocolloids B and C do not have carrageenan but only Xantano. Solution of hydrocolloid B has 1.5 to 2 gr of Xantano per liter of water.

Solution of hydrocolloid C has a content of 1.5 to 2 gr per each liter of near-frozen water.

Application of hydrocolloid A is conducted by cooking the rice in a solution containing said colloid. Application of hydrocolloid B and hydrocolloid C is done by spraying, but hydrocolloid B is applied with a room temperature solution while hydrocolloid C is applied at a temperature of about 1° C.

Quantities of these solutions added to a kg of dry rice would be as follows:

Hydrocolloid A is added in a solution at a rate of 1 liter of solution for each kilogram of rice. Cooking time ranges between 20 and 35 minutes.

Hydrocolloid B is sprayed, following rice curing with the salt and cane sugar in vinegar solution, in a solution with 60 to 100 gr of hydrocolloid B for each kg of rice.

Hydrocolloid C is added by spraying the rice with an amount equal to 10 to 20 ml for each kg of rice used in the finished product.

This curing vinegar solution comprises 13 to 19% sugar weight/volume of solution, and a salt quantity equal to 8% weight/volume of solution. The quantity of this solution added to the rice ranges from 6 to 8% volume/weight of the rice.

Stay time of the freezing product in liquid nitrogen ranges from 40 to 60 seconds.

The following are examples of applications of the teaching hereof, and they are merely illustrative and must not be deemed as limitative.

### EXAMPLES

### Example 1

2.000 kg of rice were measured and washed until free of aleurone and other grain tissues removed by polishing. Then a drained product was cooked in 2.000 L of a water solution with 16 gr of hydrocolloid A (carrageenan). Cooked product was cured with vinegar, cane sugar, and salt. Rice was then sprayed with 1 L of a Xantano solution containing 1 gr of this hydrocolloid B. This rice was used to make sushi, which was frozen by immersion on liquid nitrogen, and 20 ml of a solution made with 1 L of water at 1° C. containing 1 gr of Xantano (hydrocolloid C) was sprayed onto it. This was stored in freezers for 6 months and, when thawed, rice kept its fluffiness, softness, and texture qualities.

### Example 2

3.000 kg of rice were measured and washed until all residues from its polishing were removed. Then this drained product was added 3.000 L of water with 24 gr of carrageenan dissolved therein, allowing sitting for 35 minutes. This rice was immediately cooked with this water for 25 minutes. Cooked product was cured with vinegar, cane sugar, and salt. Rice was then sprayed with 1 L of a Xantano solution containing 1 gr of this hydrocolloid B. This rice was used to make sushi, which was frozen by immersion on liquid nitrogen, and 20 ml of a solution made with 1 L of water at 1° C. containing 1 gr of Xantano (hydrocolloid C) was sprayed onto it. This was stored in freezers for 6 months and, when thawed, rice kept its fluffiness, softness, and texture qualities.

### Example 3

4.000 kg of rice were measured and washed seven times. Then this drained product was added 4.000 L of water with 32 gr of hydrocolloid A (carrageenan) dissolved therein, allowing sitting for 35 minutes. This rice was immediately cooked with this water for 20 to 25 minutes. Rice was then sprayed with 1 L of a Xantano solution containing 1 gr of this hydrocolloid B. This rice was used to make sushi, which was frozen by immersion on liquid nitrogen, and 20 ml of a solution made with 1 L of water at 1° C. containing 1 gr of Xantano (hydrocolloid C) was sprayed onto it. This was stored in freezers for 6 months and, when thawed, rice kept its fluffiness, softness, and texture qualities.

### Example 4

5.000 kg of rice were measured and washed. Then this drained product was added 5.000 L of water with 40 gr of hydrocolloid A (carrageenan), and immediately after, rice was cooked for 20 to 25 minutes. Rice was then sprayed with 1 L of a Xantano solution containing 1 gr of this hydrocolloid B. This rice was used to make sushi, which was frozen by immersion on liquid nitrogen, and 20 ml of a solution made with 1 L of water at 1° C. containing 1 gr of Xantano (hydrocolloid C) was sprayed onto it. This was stored in freezers for 6 months and, when thawed, rice kept its fluffiness, softness, and texture qualities.

This invention has been described with details enough so that those skilled in the art may reproduce it and get the results stated herein. However, any person skilled in the art of this present invention may do non-described modifications thereto but if the application of such modifications in the process requires the subject matter included in the following claims, such structures shall be included in the scope of this invention.

1. Rice conditioning process and freezing of products made with such rice, of a kind where the rice is washed, cooked, cured with a vinegar, sugar, and salt solution, and is then used to prepare a meal containing said rice, characterized by said cooking is conducted in a hydrocolloid solution; a solution of hydrocolloids is then applied by spraying onto this cured rice after curing, and once the meal is prepared, it is frozen by immersion in liquid hydrogen during the time necessary for all components to be frozen, that is between 40 and 60 seconds, and following this foodstuff freezing a hydrocolloid based glaze is applied thereto in order to avoid dehydration during the preservation of the products made with said rice.

2. Rice conditioning process and freezing of products made with such rice according to claim 1, characterized by the hydrocolloid used while cooking is a water solution of carrageenan, where said carrageenan is added at a rate of 7 or 8 gr for each liter of solution and this carrageenan solution is added at a rate of 1 liter of solution for each kilogram of rice.

3. Rice conditioning process and freezing of products made with such rice according to a claim 1, characterized by the solution sprayed following said rice curing is a solution of only xantano at a rate of 1 to 1.5 gr of xantano per liter of solution, and this solution is sprayed on the rice at room temperature, and at a rate of 60 to 100 ml of solution for each kilogram of rice.

4. Rice conditioning process and freezing of products made with such rice according to claim 2, characterized by the solution sprayed after freezing this product has a xantano concentration ranging from 0.5 to 1.5 gr for each liter of solution, and the amount of solution sprayed ranges between 10 and 20 ml for each kilogram of rice in the product.

5. Rice conditioning process and freezing of products made with such rice according to claim 2, characterized by the solution sprayed following said rice curing is a solution of only xantano at a rate of 1 to 1.5 gr of xantano per liter of solution, and this solution is sprayed on the rice at room temperature, and at a rate of 60 to 100 ml of solution for each kilogram of rice.

6. Rice conditioning process and freezing of products made with such rice according to claim 3, characterized by the solution sprayed after freezing this product has a xantano concentration ranging from 0.5 to 1.5 gr for each liter of solution, and the amount of solution sprayed ranges between 10 and 20 ml for each kilogram of rice in the product.

7. Rice conditioning process and freezing of products made with such rice according to claim 5, characterized by the solution sprayed after freezing this product has a xantano concentration ranging from 0.5 to 1.5 gr for each liter of solution, and the amount of solution sprayed ranges between 10 and 20 ml for each kilogram of rice in the product.
